(19) United States
(12) Patent Application Publication
(10) Pub. No.: US 2010/0187714 A1
(43) Pub. Date: Jul. 29, 2010

(54) PATTERN GENERATION METHOD, RECORDING MEDIUM, AND PATTERN FORMATION METHOD

(76) Inventors: Ayumi KOBIKI, Yokohama-shi (JP); Takeshi KOSHIBA, Yokohama-shi (JP); Hidefumi MUKAI, Kawasaki-shi (JP); Yasutada NAKAGAWA, Yokohama-shi (JP); Seiro MIYOSHI, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/691,813

(22) Filed: Jan. 22, 2010

(30) Foreign Application Priority Data
Jan. 26, 2009 (JP) 2009-014558

(51) Int. Cl. B32B 3/26

(52) U.S. Cl. 264/135

(57) ABSTRACT

A pattern generation method of generating a three-dimensional pattern to be formed at a template for use in a method of forming a pattern by filling a resist material in the three-dimensional pattern of the template includes performing at least one of adjustment of a depth of the three-dimensional pattern and division of the three-dimensional pattern, based on a relationship between a filling time of the resist material and a dimension or shape of the three-dimensional pattern.

### CROSS-REFERENCE TO RELATED APPLICATIONS

This application is based upon and claims the benefit of priority from prior Japanese Patent Application No. 2009-014558, filed Jan. 26, 2009, the entire contents of which are incorporated herein by reference.

### BACKGROUND OF THE INVENTION

1. Field of the Invention

The present invention relates to a pattern generation method and pattern formation method using imprint lithography and, more particularly, to a pattern generation method of generating a pattern of an imprint lithography template to be used in the development and fabrication of a device, a computer-readable recording medium configured to store program instructions to be applied to the pattern generation method, and a pattern formation method using imprint lithography.

2. Description of the Related Art

As a technique capable of forming micropatterns and increasing the productivity at the same time in the semiconductor element fabrication process, imprint lithography that transfers a pattern formed at a template onto a transfer target substrate is attracting attention.

Imprint lithography is a method by which a template having a pattern to be transferred is pressed against a photocurable organic material layer applied on a substrate, and the pattern is transferred onto the organic material layer by curing it by irradiating it with light (see, e.g. Jpn. Pat. Appln. KOKAI Publication No. 2001-068411, Jpn. Pat. Appln. KOKAI Publication No. 2000-194142).

In imprint lithography, to eliminate defects caused by incomplete filling of the organic material in the pattern formed on the template, it is necessary to prolong the time after the template is brought into contact with the organic material and before the light is radiated, thereby completely filling the organic material in the pattern of the template. However, if the time after the template is brought into contact with the organic material and before the light is radiated is prolonged more than necessary, problems such as the decrease in throughput arise.

### BRIEF SUMMARY OF THE INVENTION

According to a first aspect of the present invention, there is provided a pattern generation method of generating a three-dimensional pattern to be formed at a template for use in a method of forming a pattern by filling a resist material in the three-dimensional pattern of the template comprising: performing at least one of adjustment of a depth of the three-dimensional pattern and division of the three-dimensional pattern, based on a relationship between a filling time of the resist material and a dimension or shape of the three-dimensional pattern.

According to a second aspect of the present invention, there is provided a computer-readable recording medium configured to store a program instruction to be applied to a method of generating a three-dimensional pattern to be formed at a template for use in a method of forming a pattern by filling a resist material in the three-dimensional pattern of the template, the program instruction causing a computer to execute at least one of adjustment of a depth of the three-dimensional pattern, and division of the three-dimensional pattern, based on a relationship between a filling time of the resist material and a dimension or shape of the three-dimensional pattern.

### BRIEF DESCRIPTION OF THE SEVERAL VIEWS OF THE DRAWING

FIG. 1 is a schematic view showing an imprinting apparatus for use in imprint lithography according to an embodiment of the present invention;

FIG. 2 is a flowchart of a micropattern formation method using imprinting according to an embodiment of the present invention;

FIGS. 3A to 3G are views showing the steps of a pattern transfer method according to an embodiment of the present invention;

FIGS. 4A and 4B are views each showing the dependence of the filling time on the pattern size/recess depth according to an embodiment of the present invention;

FIG. 5 is a graph showing the dependence of the filling time on the pattern size/recess depth according to an embodiment of the present invention;

FIG. 6 is a graph showing the relationship between the number of non-filling defects and the filling time based on the pattern size according to an embodiment of the present invention;

FIGS. 7A and 7B are graphs for explaining an outline of pattern formation method example 1 according to an embodiment of the present invention;

FIG. 8 is a view for explaining the adjustment of the recess depth based on the relationship between the pattern dimension and the filling time in connection with pattern formation method example 1;

FIGS. 9A and 9B are graphs for explaining the adjustment of the recess depth based on the relationship between the pattern shape and the filling time in connection with pattern formation method example 2 according to an embodiment of the present invention;

FIGS. 10A and 10B are views for explaining an outline of pattern formation method example 2;

FIGS. 11A and 11B are graphs for explaining pattern division taking account of a necessary residual film in connection with pattern formation method example 3 according to an embodiment of the present invention;

FIGS. 12A and 12B are views for explaining an outline of pattern formation method example 3;

FIG. 13 is a flowchart of a pattern generation method according to an embodiment of the present invention;

FIG. 14 is a flowchart of a pattern generation method according to an embodiment of the present invention;

FIG. 15 is a view for explaining an outline of write data division method example 1 according to an embodiment of the present invention;

FIGS. 16A to 16G are views showing the steps of write data division method example 1 according to the embodiment of the present invention;

FIG. 17 is a view for explaining an outline of write data division method example 2 according to an embodiment of the present invention; and

FIGS. 18A to 18G are views showing the steps of write data division method example 2 according to the embodiment of the present invention.

### DETAILED DESCRIPTION OF THE INVENTION

Embodiments of the present invention will be explained below with reference to the accompanying drawing.

### [1] IMPRINTING APPARATUS

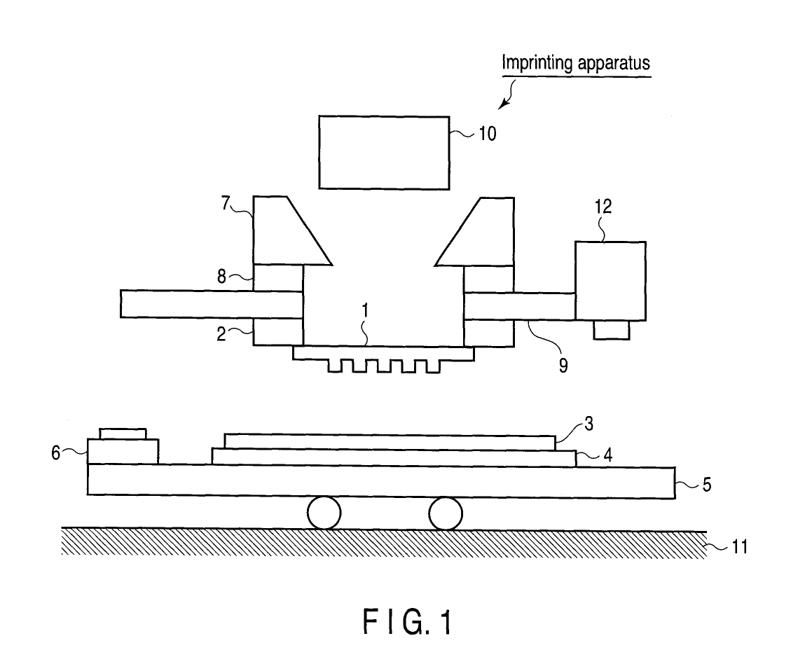

FIG. 1 is a schematic view showing the arrangement of an imprinting apparatus for use in imprint lithography according to an embodiment of the present invention. An outline of the arrangement of the imprinting apparatus will be explained below.

As shown in FIG. 1, the imprinting apparatus includes a template 1, template stage 2, transfer target substrate 3, chuck 4, sample stage 5, reference mark table 6, alignment sensors 7, alignment stage 8, base 9, UV light source 10, stage platen 11, and misalignment testing mechanism 12. Note that the template 1 and transfer target substrate 3 are attached to the imprinting apparatus when transferring a pattern by using the apparatus, and detached from the apparatus except when performing imprinting.

A three-dimensional transfer pattern is formed at the template 1. The template 1 is held on the template stage 2 such that the transfer pattern faces the transfer target substrate 3. The template 1 is made of a material such as quartz or fluorite that transmits ultraviolet light (UV light).

The template stage 2 includes a correction driving means for finely adjusting the position of the template 1. A good pattern can be formed because the template stage 2 controls the posture of the template 1 when transferring the pattern. Note that a pressurizing unit for pressing the template 1 against the transfer target substrate 3 is a mechanism separated from the template stage 2, but is not shown in FIG. 1 like the correction driving means for finely adjusting the position of the template 1.

The chuck 4 is fixed to the sample stage 5, and holds the transfer target substrate 3. The sample stage 5 is preferably drivable along the X-axis, Y-axis, and Z-axis and around these three axes, i.e., a total of six axes. The reference mark table 6 is fixed on the sample stage 5, and serves as the reference position of the imprinting apparatus. The calibration of the alignment sensors 7 and the posture control and adjustment of the template 1 are performed by using a reference mark placed on the reference mark table 6.

The alignment sensors 7 are fixed on the alignment stage 8. When aligning the template 1 and transfer target substrate 3, the alignment sensors 7 sense an alignment mark (not shown) formed as an alignment reference on the transfer target substrate 3, and a template alignment mark (not shown) formed on the template 1 so as to face the alignment mark on the substrate. Note that FIG. 1 shows only two, right and left alignment sensors 7, but the apparatus preferably includes four or more alignment sensors 7.

A measurement method using the alignment sensors 7 is as follows. First, the sample stage 5 is moved to a position where it is possible to simultaneously sense the alignment marks (e.g., diffraction gratings) formed on the template 1 and transfer target substrate 3. Then, light is emitted to each alignment mark, and a relative positional difference is measured from the center of gravity of light having returned to the alignment sensor 7 after being diffracted and reflected. The correction driving means controls the posture of the template 1 by using the sensed relative positions of the alignment marks on the template 1 and transfer target substrate 3. This makes it possible to perform high-accuracy pattern transfer.

The UV light source 10 is fixed to a main platen (not shown). The UV light source 10 exposes a photosensitive resin (not shown) applied on a transfer position on the transfer target substrate 3 to ultraviolet light through the template 1. Note that the UV light source 10 is installed immediately above the temperature 1 in FIG. 1, but the installation position is not limited to this position.

The misalignment testing mechanism 12 is installed on the base 9 of the imprinting apparatus. The misalignment testing mechanism 12 measures the difference between the relative positions of the pattern formed on the transfer target substrate 3 and the transfer pattern of the template 1, which is patterned on the photosensitive resin applied on the transfer target substrate 3.

### [2] PROCEDURE OF IMPRINTING PROCESS

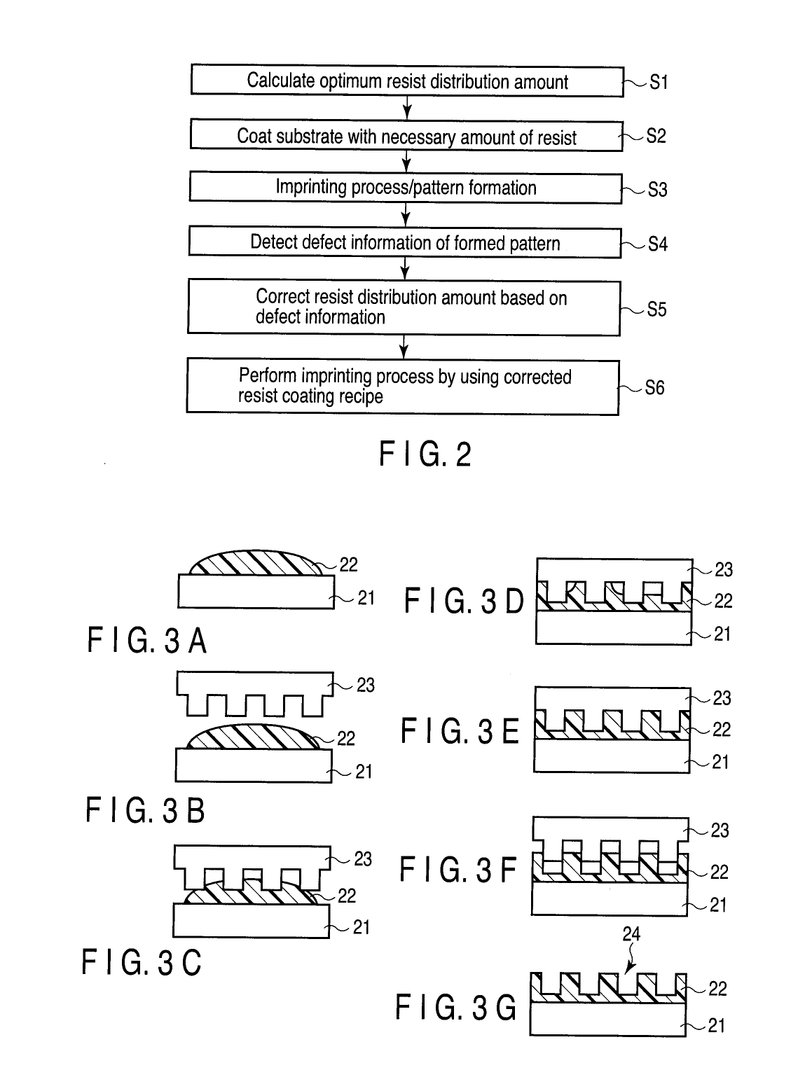

FIG. 2 is a flowchart of a micropattern formation method using imprinting according to an embodiment of the present invention. The procedure of the imprinting process will be explained below.

First, a resist coating recipe taking account of the density of a pattern formed at a template is formed. The volatilization amount of an imprinting resist material during the process (e.g., the volatilization amount of the resist produced after the resist is applied on the substrate and before the three-dimensional pattern of the template is transferred) is compensated with respect to the recipe, thereby calculating an optimum resist distribution amount (S1).

Then, a transfer target substrate is coated with a necessary amount of the resist controlled in step S1 in accordance with the recipe (S2). A general imprint lithography process uses a resist coating method by which a necessary amount of a resist is dropped at a predetermined interval by using an inkjet nozzle for each shot. The local optimization of the resist amount is controlled by the distribution of the resist amount to be dropped.

After the transfer target substrate is coated with the proper amount of the resist in step S2, the template is brought into contact with the resist and held in this state, thereby filling the liquid-like resist in recesses of the template pattern. Note that the time required to fill the resist in the template pattern is generally short for fine patterns, and long for large patterns such as a dummy pattern and mark. After the resist is sufficiently filled in the template pattern, the resin of the resist is cured by emitting UV light from above the template for a desired time, and the template is removed from the resist. The pattern is formed by this imprinting process (S3).

Subsequently, the transfer target substrate on which the pattern is formed in step S3 is loaded into a defect testing apparatus, and a pattern defect test is conducted. In this step, the defect testing apparatus is used to perform a die-to-die or cell-array pattern defect test, thereby detecting a defect caused by imprinting (S4). Although a defect such as particle dust caused by a factor other than the imprinting process factor is naturally detected as well, the test is conducted to mainly detect and extract a non-filling defect called non-fill unique to imprinting. The non-filling defect often occurs as a common defect in a place where the resist material is locally insufficient, or when the filling time is insufficient. Since, however, a wafer has the unevenness of an undercoat or the like, the non-filling defect sometimes occurs owing to the wafer surface trend. In either case, the non-filling defect becomes a large-scale defect or large-size defect in many cases, and can easily be classified. Therefore, the non-filling defect may also be classified by SEM-Review. Note that the detection of a defect unique to imprinting performed using the optical defect testing apparatus has been explained as an example. However, this embodiment is not limited to this test, and a similar test can be conducted by using an EB defect testing apparatus or the like.

The defect information detected in step S4 is fed back to the resist coating amount distribution, thereby correcting it (S5). Of detected defects, information of only defects unique to imprinting, particularly, information of only the non-filling defect is often used. The information to be used contains the position coordinates of the defect and the defect size. Based on these pieces of information, a locally deficient resist coating amount is calculated, and the drop amount is adjusted and controlled, thereby forming a drop recipe having a new resist coating amount distribution. The drop amount can be adjusted and controlled by increasing or decreasing the drop amount per drop, or increasing or decreasing the density and interval of drop.

Then, a necessary amount of the resist is applied in accordance with the drop recipe formed in step S5. After that, an imprinting operation similar to that in step S3 is performed (S6). In this step, the resist coating process can be executed on the transfer target substrate after the resist pattern already formed on it is removed, or on a transfer target substrate different from the substrate on which the resist pattern is formed.

A further optimized resist coating recipe can be formed by continuing steps S1 to S6 described above until there is no more non-filling defect. This makes it possible to apply imprint lithography to an actual process, and form a defect-free, high-accuracy pattern.

### [3] PATTERN TRANSFER METHOD

FIGS. 3A to 3G are views showing the individual steps of a pattern transfer method according to an embodiment of the present invention. The pattern transfer method using imprint lithography will be explained below. Note that this pattern transfer is performed in the imprinting process in step S3 of FIG. 2 by using the imprinting apparatus shown in FIG. 1.

First, as shown in FIG. 3A, a substrate (transfer target substrate) 21 is coated with a photocurable organic material (resist) 22 of one shot. Note that the coating of the organic material 22 is performed by spraying organic material droplets by the inkjet method. FIG. 3A is an enlarged view of one droplet.

Then, as shown in FIGS. 3B and 3C, a quartz template 23 having a pattern of one shot is brought into contact with the organic material 22. After that, the template 23 is moved closer to the wafer as shown in FIG. 3D. The template 23 is held in this state until the organic material 22 penetrates the micropattern of the template 23. As shown in FIG. 3D, the filling of the organic material 22 is initially insufficient, and filling defects occur in corners of the pattern. When the time for filling the resist in the pattern is prolonged, however, as shown in FIG. 3E, the organic material 22 fills all the corners of the pattern, and the filling defects reduce. In this state, the organic material 22 is cured by irradiation with (UV) light.

After that, as shown in FIG. 3F, the template 23 is released from the organic material 22.

Consequently, as shown in FIG. 3G, a three-dimensional pattern 24 of the template 23 is transferred onto the organic material 22.

### [4] RELATIONSHIP BETWEEN PATTERN SIZE AND FILLING TIME

In imprint lithography, the time required to completely fill the organic material in the grooves of the template is related to the pattern size and the recess depth of the pattern.

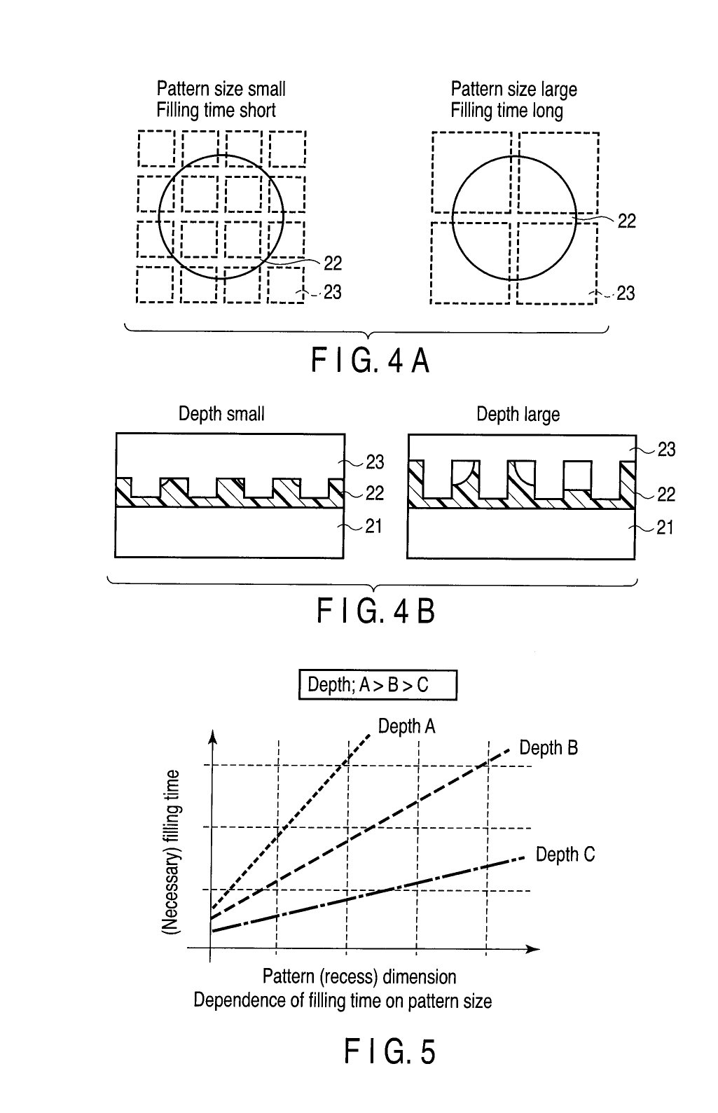

FIG. 4A is a plan view of the three-dimensional pattern surface of the template when the resist is filled. FIG. 4B is a sectional view of the template when the resist is filled. As shown in FIG. 4A, for example, when the pattern size is small, the organic material 22 is filled in the grooves of the template 23 within a short time. Also, as shown in FIG. 4B, when the recesses of the pattern are shallow, the organic material 22 is filled in the grooves of the template 23 within a short time. The dependence of the filling time on the pattern size and the recess depth as described above is as follows. That is, as shown in FIG. 5, the filling time shortens as the pattern size decreases when the recess depth remains the same, and shortens as the recess depth decreases when the pattern size remains the same.

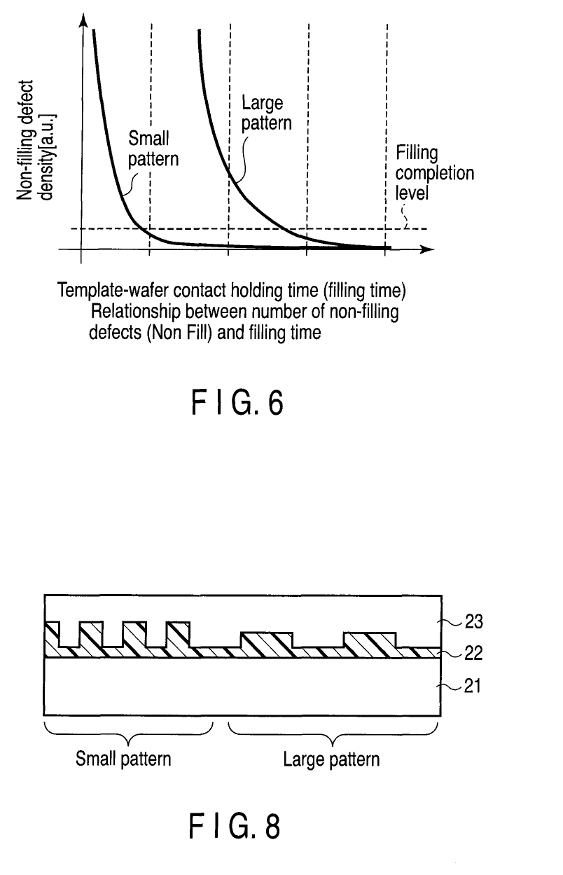

FIG. 6 is the plot of the non-filling defect density as a function of the time required to fill the organic material in the pattern. FIG. 6 shows that the time required to reach the filling completion level is shorter for a small pattern than for a large pattern.

As described above, the organic material for imprinting is filled in the micropattern of the template by the capillary phenomenon. Therefore, the time required to fill the organic material in the pattern recesses prolongs as the pattern dimension increases or the pattern recesses deepen, and a non-filling defect occurs if the waiting time before light irradiation is short. To prevent this non-filling defect, it is only necessary to well prolong the waiting time. In this case, however, the throughput decreases.

Accordingly, an embodiment of the present invention proposes a pattern formation method using a template in which the recess depth is adjusted by taking account of the pattern dimension or the like.

### [5] PATTERN FORMATION METHOD

### [5-1] Pattern Formation Method Example 1

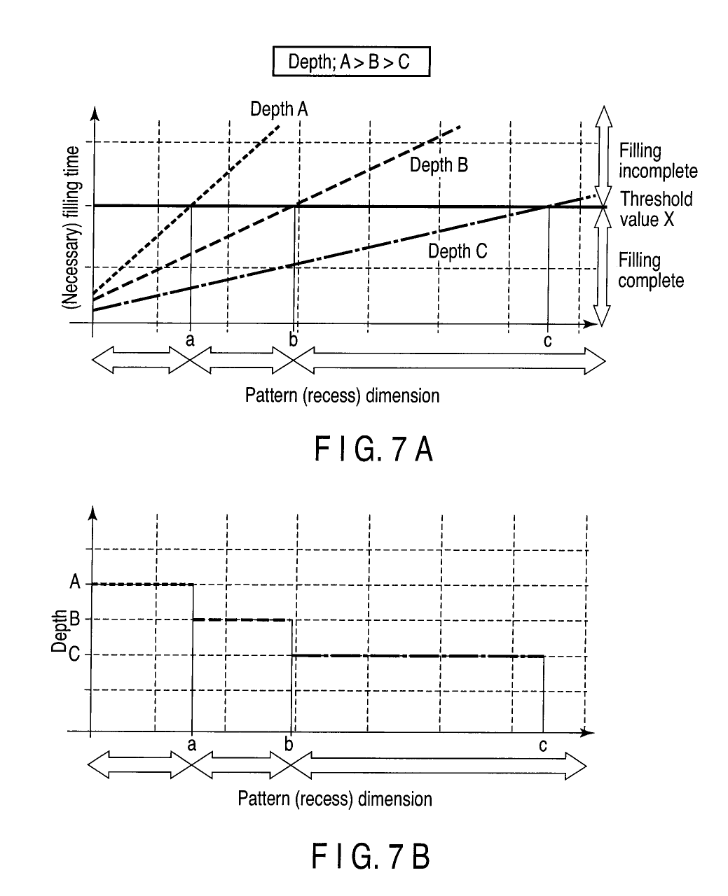

Pattern formation method example 1 will be explained below with reference to FIGS. 7A, 7B, and 8. Pattern formation method example 1 is an example in which the recess depth of the template is adjusted by taking account of the pattern dimension (size). Note that in FIGS. 7A and 7B, all patterns are set to have the same shape (e.g., a line shape).

As shown in FIG. 7A, when the depth has condition A>B>C, the organic material filling time shortens as the pattern dimension decreases and the depth decreases. For example, depth A is 100 nm, depth B is 80 nm, and depth C is 50 nm. Under the condition, in pattern formation method example 1, the pattern dimensions are grouped within the range (threshold X) in which filling is completed within a target time, and the recess depth of each group is adjusted.

More specifically, let a, b, and c be the intersections of threshold X and the straight lines of depths A, B, and C. Assume that the recess depth of a pattern dimension smaller than a is less than or equal to depth A, the recess depth of a pattern dimension greater than or equal to a and less than b is less than or equal to depth B, and the recess depth of a pattern dimension greater than or equal to b and less than or equal to c is depth C (FIG. 7B). The recess depth of the template is thus grouped in three levels so as to complete the filling of the organic material within a target time even when the pattern dimension is large. Note that the method of grouping the recess depth of the template is not limited to the three levels as described above.

As described above, when the surface of the template 23 has both a small pattern and large pattern as shown in FIG. 8, pattern formation method example 1 uses the template 23 in which recesses of the large pattern are made shallower than those of the small pattern. This makes it possible to fill the organic material 22 in all pattern recesses within a target time.

Note that in this example, when the larger pattern of the template is shallowed by taking account of the filling time, the small pattern of the template need not be shallowed unlike the large pattern. When etching the residual film of the resist pattern after the pattern is transferred by imprinting, the film thickness of the resist pattern must be greater than or equal to a predetermined value in order to ensure the etching resistance of the resist pattern. For this purpose, the depth of the small pattern of the template is preferably greater than or equal to that of the large pattern.

On the other hand, when the film thickness of the resist pattern corresponding to the large pattern of the template decreases, the edges of the resist pattern are etched in the etching step and the pattern dimension varies in some cases. However, no large problem arises because the ratio of the dimensional variation in the whole pattern is low. Also, the large pattern is used to form, e.g., a dummy pattern or alignment mark. Since the larger pattern is not required to have high dimensional accuracy in many cases, no large problem arises.

### [5-2] Pattern Formation Method Example 2

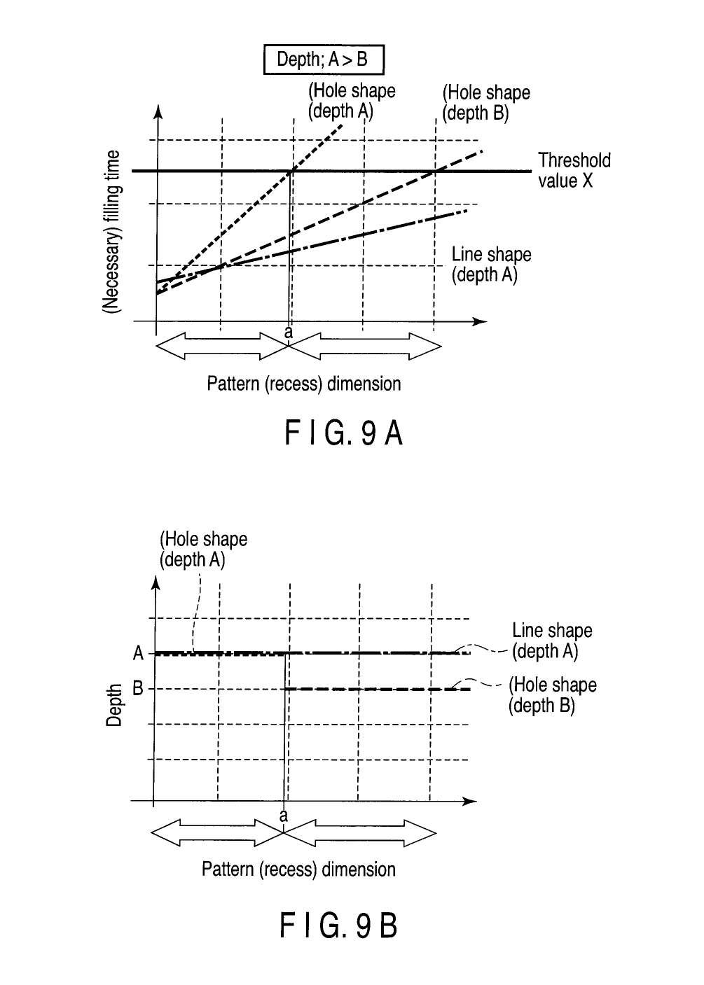

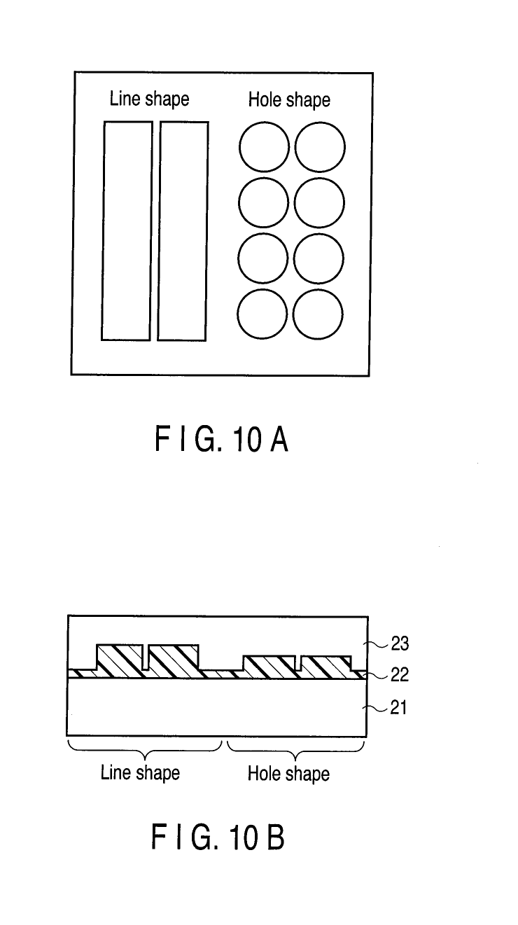

Pattern formation method example 2 will be explained below with reference to FIGS. 9A, 9B, 10A, and 10B. Pattern formation method example 2 is an example in which the recess depth of the template is adjusted by taking account of the pattern shapes (hole shape and line shape). Assume that the dimensions of the hole shape pattern and line shape pattern are the dimensions of their diameters.

As shown in FIGS. 9A and 9B, the filling time of the hole shape is longer than that of the line shape; the filling time depends on the pattern shape as well.

Therefore, letting A be the depth of a line shape template and B be the depth of a hole shape template, the hole shape is made shallower than the line shape. Examples of the hole shape and line shape are a pad, dummy pattern, alignment mark, and fringe (extracting pad).

Note that in the hole shape examples shown in FIGS. 9A and 9B, the difference between the hole shape (depth A) and hole shape (depth B) is that the depth of the former is made equal to that of the line system, and the depth of the latter is made less than that of the line system.

In pattern formation method example 2, the filling times of the hole shape and line shape are different not only because the recess volumes are different.

Also, the hole shape is preferably made shallower than the line shape for the same pattern size.

In pattern formation method example 2 as described above, as shown in FIGS. 10A and 10B, when the template surface has different pattern shapes (e.g., the line shape and hole shape), the organic material 22 can completely be filled in all pattern recesses within a target time by using the template 23 in which the recesses of a pattern shape (e.g., the hole shape) requiring a long filling time are made shallower than those of a pattern shape (e.g., the line shape) requiring a short filling time.

### [5-3] Pattern Formation Method Example 3

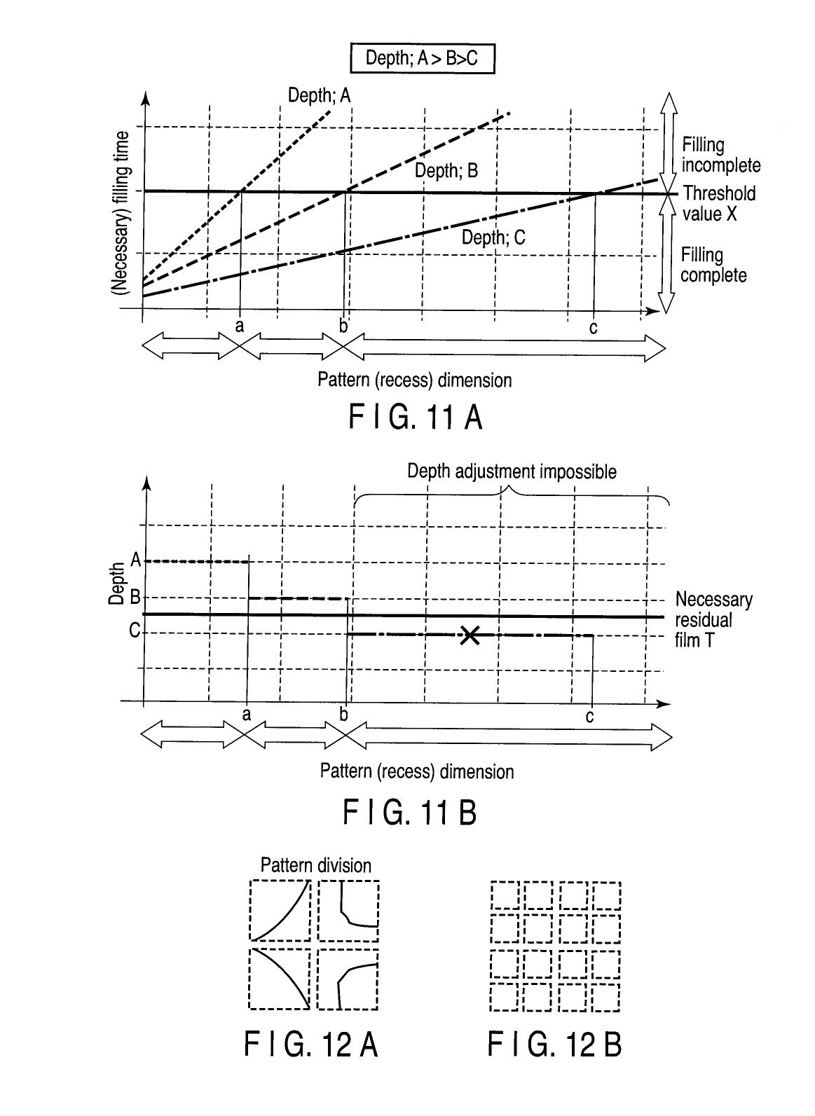

Pattern formation method example 3 will be explained below with reference to FIGS. 11A, 11B, 12A, and 12B. Pattern formation method example 3 is an example in which pattern division is performed if the recess depth of the template adjusted by pattern formation method example 1 or 2 described above cannot ensure the film thickness required to process the organic material.

As shown in FIGS. 11A and 11B, assume that the recess depth of a pattern dimension smaller than a is defined as less than or equal to depth A, the recess depth of a pattern dimension greater than or equal to a and less than b is defined as less than or equal to depth B, and the recess depth of a pattern dimension greater than or equal to b and less than or equal to c is defined as depth C, in accordance with pattern formation method example 1 described earlier. However, the adjustment of the depth is limited because it is necessary to assure the film thickness required for processing. For example, for necessary residual film T, depth C cannot secure the film thickness required for processing. For a pattern dimension greater than or equal to b and less than or equal to c, therefore, as shown in FIGS. 12A and 12B, the pattern is divided, and the depth is calculated from the filling time of the divided pattern size. The pattern is kept divided until the depth can ensure the film thickness required for processing.

As described above, pattern formation method example 3 determines whether the recess depth of the template adjusted by above-mentioned pattern formation method example 1 or 2 can secure the film thickness required to process the organic material. If the film thickness required to process the organic material is not secured, the pattern is divided. This makes it possible to give the processing resistance to the organic film thickness after the pattern is formed.

Note that it is also possible to combine pattern formation method examples 1 and 2, and apply the combination to pattern formation method example 3.

Note also that in pattern formation method example 3, whether the film thickness required to process the organic material is ensured is determined based on the recess depth of the template adjusted by pattern formation method example 1 or 2. However, the present invention is not limited to this. That is, it is also possible to divide the pattern by determining whether the film thickness required to process the organic material is assured, based on the recess depth of the template not adjusted by pattern formation method example 1 or 2.

### [6] PROCEDURE OF TEMPLATE PATTERN GENERATION METHOD

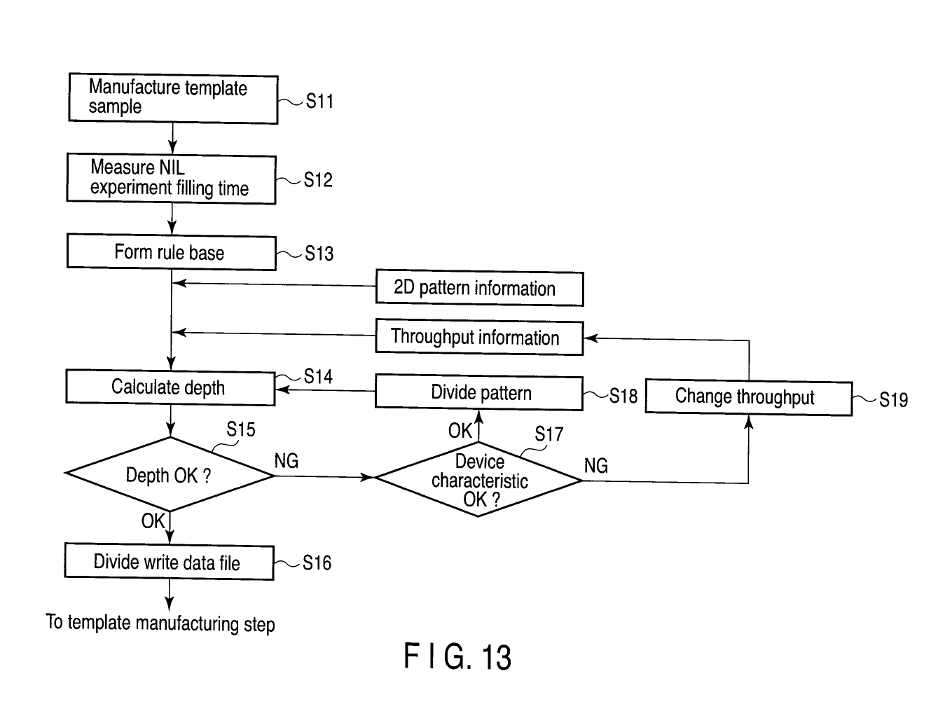

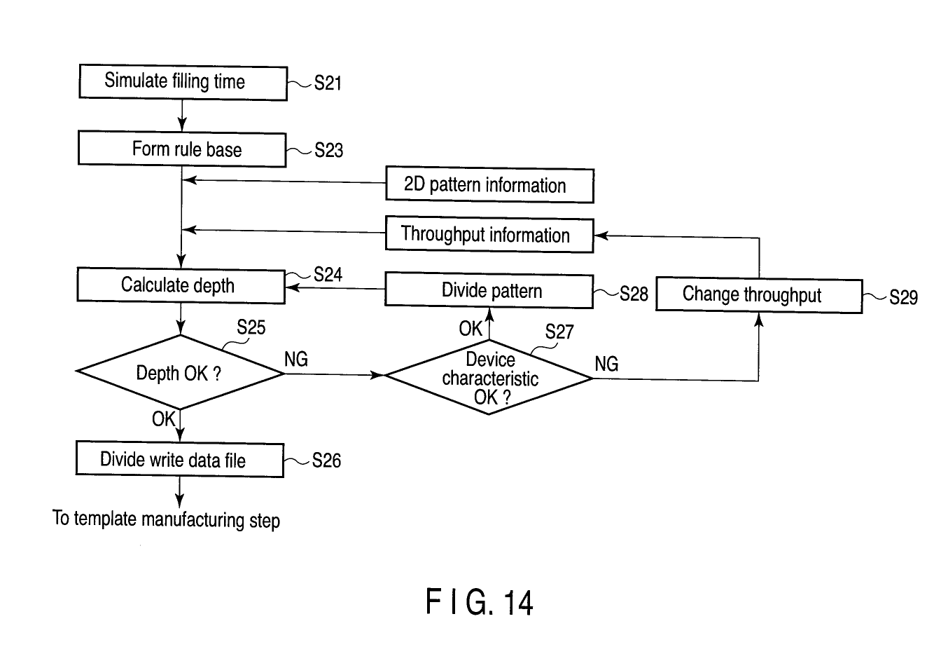

FIGS. 13 and 14 are flowcharts of a template pattern generation method according to an embodiment of the present invention.

First, as shown in FIG. 13, a template on which patterns having various pattern sizes and shapes corresponding to semiconductor device design patterns is manufactured (S11). The material filling time during imprinting is measured using the template (S12), and rules for calculating an optimum recess depth of the template are formed (S13). Note that as shown in FIG. 14, the rules may also be formed by calculating the pattern dimension and resist material filling time by simulation without forming any testing template (S21). It is also possible to omit the rule formation step (S13 or S25).

Then, 2D pattern information and throughput information are input to the rules, and the recess depth of the template is calculated for each pattern size or shape (S14 or S24). More specifically, the recess depth of the template is defined in accordance with pattern formation method example 1 or 2 described previously.

Subsequently, whether the calculated depth can secure the film thickness required for processing is determined in the same manner as in above-mentioned pattern formation method example 3 (S15 or S25). Note that determination step S15 or S25 may also be executed by omitting depth calculation step S14 or S24.

If the film thickness can be assured, the file of mask write data is divided based on the recess depth calculated in step S14 or S24 (S16 or S26), and the process advances to the template manufacturing process.

On the other hand, if the film thickness cannot be ensured, whether the pattern can be divided based on the device characteristic is checked (S17 or S27). That is, whether the pattern is a dividable pattern such as a dummy pattern is checked. If pattern division is possible for the device, the pattern is divided (S18 or S28), and the depth is recalculated in accordance with the rules (S14 or S24). The pattern is kept divided until the depth can secure the film thickness. On the other hand, if pattern division is impossible for the device, the throughput is changed (S19 or S29), and the depth is recalculated in accordance with the changed rules.

Note that when omitting the rule formation step (S13 or S25) and the like, the pattern division and the calculation of the filling time are repeated until the result of the filling time in step S12 or S22 satisfies the desired throughput. To satisfy the desired throughput, the pattern depth is appropriately decreased. When the pattern depth is decreased, whether a sufficient film thickness can be secured is verified so that the dimensional variation when etching the resist pattern falls within the allowable range.

Note that the above-described pattern data generation method can also be applied, as a program executable by a computer, to various apparatuses by writing the program to a recording medium such as a magnetic disk, optical disk, or semiconductor memory, or by transmitting the program by a communication medium. A computer that implements this apparatus reads the programs recorded on the recording medium, and executes the aforementioned processing while the operation of the computer is controlled by the programs.

### [7] DIVISION METHOD EXAMPLES FOR WRITE DATA HAVING PATTERNS DIFFERENT IN DEPTH

To manufacture a template having patterns different in depth, etching must be performed a plurality of number of times, so the file of write data must be divided. Therefore, the manufacture of a template having a pattern a in which the recess depth is depth A and a pattern b in which the recess depth is depth B (depth; A>B) will be explained below.

### [7-1] Division Method Example 1

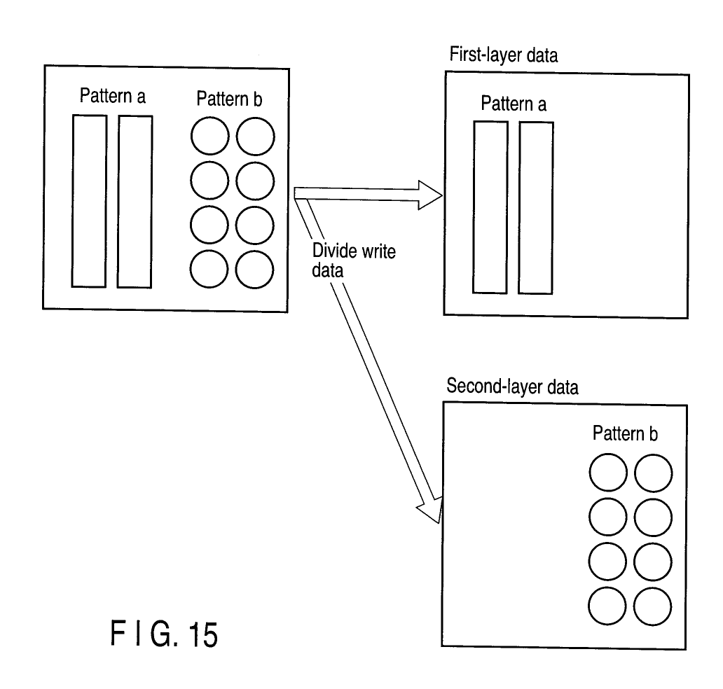

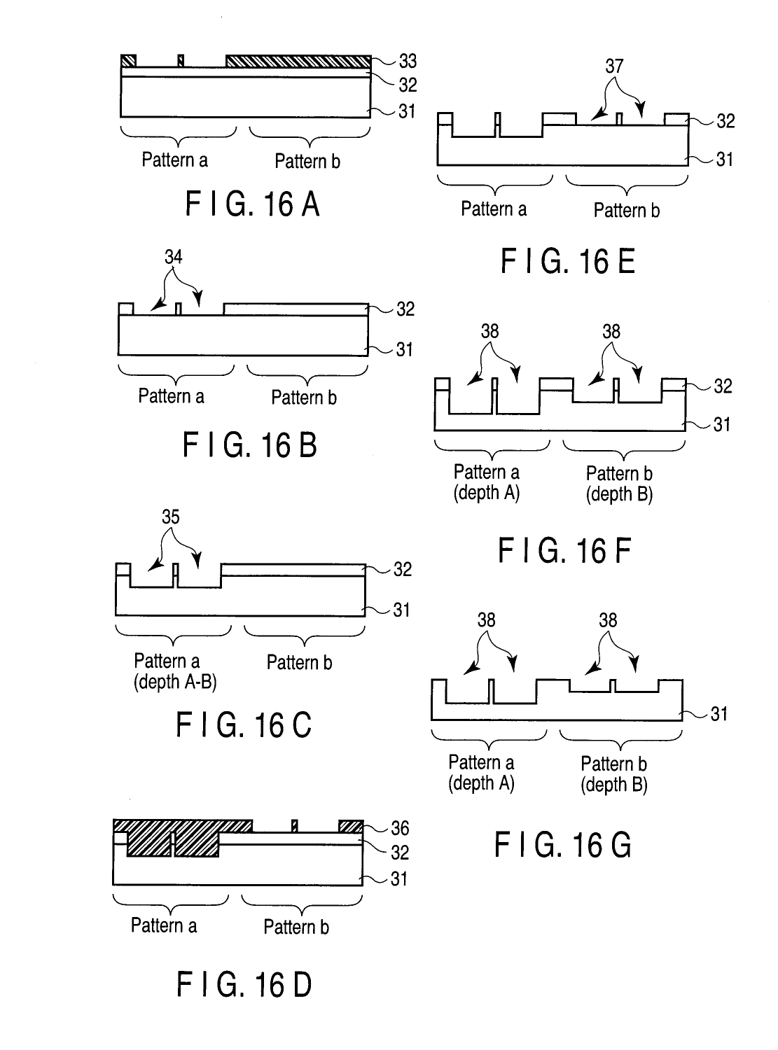

As shown in FIG. 15, division method example 1 is a method of dividing write data into pattern a and pattern b. This method will be explained in detail below with reference to FIGS. 16A to 16G.

First, as shown in FIG. 16A, a mask 32 is formed on a template 31 and coated with a resist 33. Then, the resist 33 is patterned into the shape of pattern a. The mask 32 is patterned by using the resist 33, thereby forming openings 34 as shown in FIG. 16B. After that, the resist 33 is removed. Subsequently, as shown in FIG. 16C, the template 31 is etched by using the mask 32. This etching is performed such that the depth of recesses 35 of pattern a is (A−B). As shown in FIG. 16D, a resist 36 patterned into the shape of pattern b is formed. The mask 32 is patterned by using the resist 36, thereby forming openings 37 as shown in FIG. 16E. After that, the resist 36 is removed. Then, as shown in FIG. 16F, all the patterns of the template 31 are etched by using the mask 32, thereby forming recesses 38 of patterns a and b. In this step, the template 31 is etched by depth B. After that, the mask 32 is removed. In this manner, as shown in FIG. 16G, the template 31 having pattern a in which the recesses 38 have depth A and pattern b in which the recesses 38 have depth B is manufactured.

As described above, in the write data file of division method example 1, the first-layer data (resist 32) has the shape of only pattern a, and the second-layer data (resist 36) has the shape of only pattern b (see FIG. 15).

### [7-2] Division Method Example 2

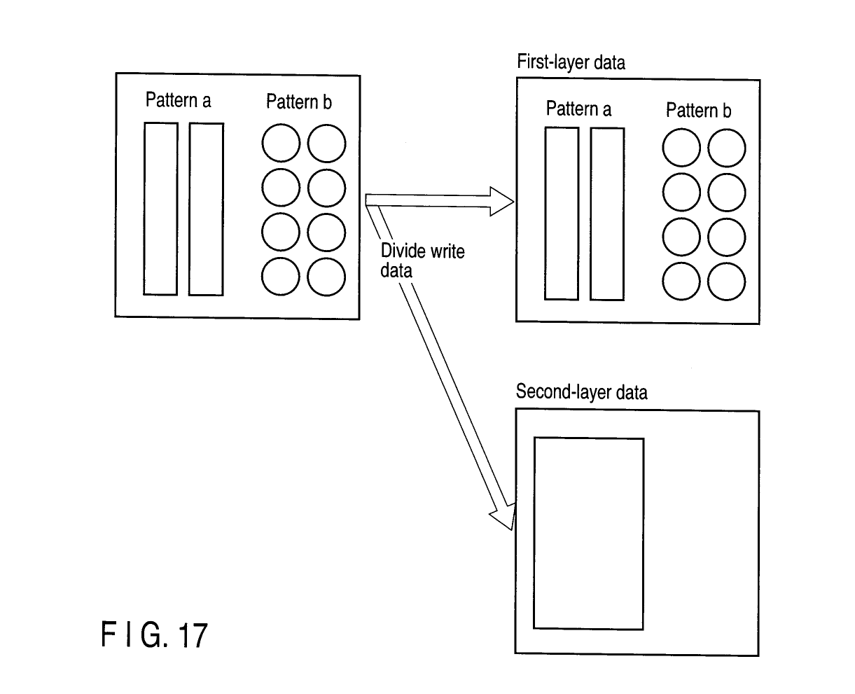

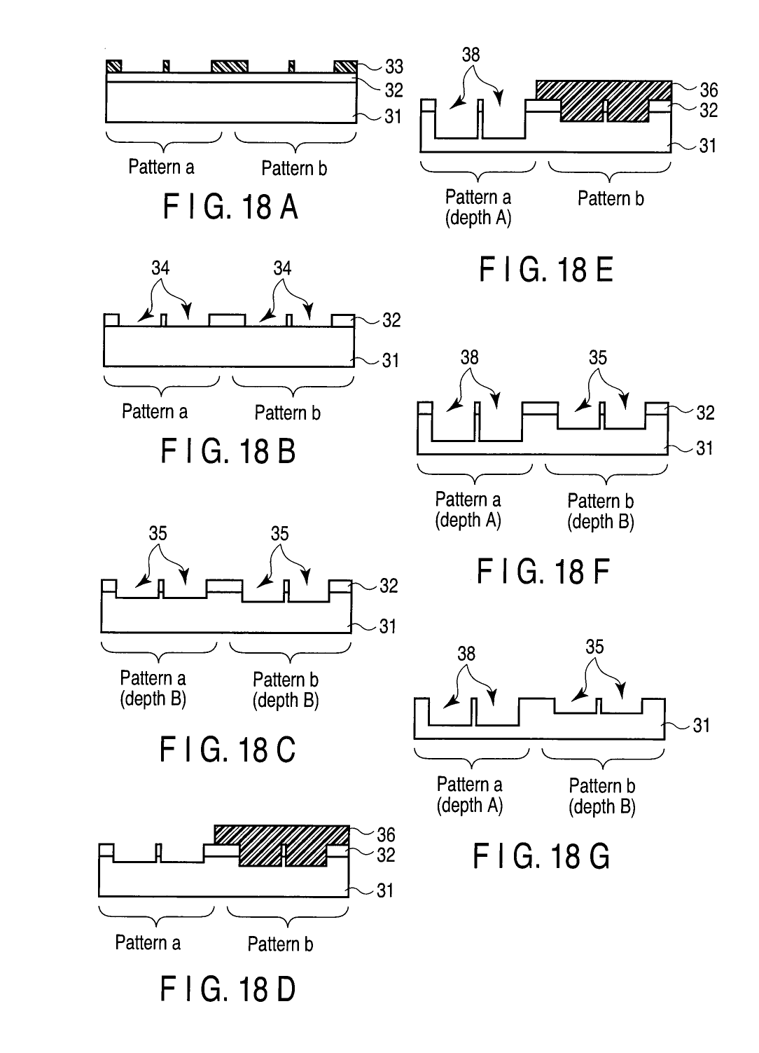

As shown in FIG. 17, division method example 2 is a method by which after both patterns a and b are initially etched to depth B, pattern b is covered with a mask, and pattern a is etched to depth A. This method will be explained in detail below with reference to FIGS. 18A to 18G.

First, as shown in FIG. 18A, a mask 32 is formed on a template 31 and coated with a resist 33. Then, the resist 33 is patterned into the shapes of patterns a and b. The mask 32 is patterned by using the resist 33, thereby forming openings 34 as shown in FIG. 18B. After that, the resist 33 is removed. Subsequently, as shown in FIG. 18C, the template 31 is etched by using the mask 32. This etching is performed such that the depth of recesses 35 of patterns a and b is B. As shown in FIG. 18D, a resist 36 covering only the region of pattern b is formed. As shown in FIG. 18E, the template 31 in the region of pattern a not covered with the resist 36 is further etched, thereby forming recesses 38. This etching is performed until the depth of the recesses 38 in the region of pattern a becomes depth A. After that, the resist 36 is removed as shown in FIG. 18F. In this way, as shown in FIG. 18G, the template 31 having pattern a in which the recesses 38 have depth A and pattern b in which the recesses 35 have depth B is manufactured.

As described above, in the write data file of division method example 2, the first-layer data (resist 33) has the shapes of both patterns a and b, and the second-layer data (resist 36) has the shape having the opening in the region of pattern a (see FIG. 17). Therefore, the write alignment of the second layer in division method example 2 can be rougher than that in division method example 1.

### [8] EFFECTS

According to an embodiment of the present invention, the recess depth of a pattern is adjusted in accordance with the pattern dimension or pattern shape in imprint lithography. More specifically, the recess depth of a template is decreased as the pattern dimension increases, and the recess depth of a template having a hole shape is made smaller than that of a template having a line shape. Since this makes it possible to control the time required to fill the organic material in the recesses of the template, it is possible to reduce non-filling defects of a pattern while suppressing the decrease in throughput.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A pattern generation method of generating a three-dimensional pattern to be formed at a template for use in a method of forming a pattern by filling a resist material in the three-dimensional pattern of the template comprising:
performing at least one of adjustment of a depth of the three-dimensional pattern and division of the three-dimensional pattern, based on a relationship between a filling time of the resist material and a dimension or shape of the three-dimensional pattern.

2. The method according to claim 1, wherein the depth of the three-dimensional pattern is adjusted such that a film thickness of a resist pattern formed by filling the resist material in the adjusted three-dimensional pattern of the template is not less than a desired thickness.

3. The method according to claim 1, wherein the three-dimensional pattern is divided such that a film thickness of a resist pattern formed by filling the resist material in the divided three-dimensional pattern of the template is not less than a desired thickness.

4. The method according to claim 1, wherein the three-dimensional pattern to be formed at the template comprises a large pattern and a small pattern different in pattern dimension, and a recess depth of the large pattern is made smaller than a recess depth of the small pattern by adjusting the depth of the three-dimensional pattern.

5. The method according to claim 4, wherein the large pattern comprises one of a dummy pattern and an alignment mark.

6. The method according to claim 1, wherein the three-dimensional pattern to be formed at the template comprises a hole pattern and a line pattern different in pattern shape, and a recess depth of the hole pattern is made smaller than a recess depth of the line pattern by adjusting the depth of the three-dimensional pattern.

7. The method according to claim 1, wherein after the depth of the three-dimensional pattern to be formed at the template is adjusted, whether a film thickness of a resist pattern formed by filling the resist material in the three-dimensional pattern is not less than a desired thickness is determined, and the three-dimensional pattern is divided if the film thickness of the resist pattern is less than the desired thickness.

8. The method according to claim 1, wherein at least one of the adjustment of the depth of the three-dimensional pattern and the division of the three-dimensional pattern is performed to satisfy an allowable resist material filling time.

9. The method according to claim 8, wherein at least one of the adjustment of the depth of the three-dimensional pattern and the division of the three-dimensional pattern is performed, and, if the resist material is not completely filled in the three-dimensional pattern within the allowable resist material filling time, the allowable resist material filling time is prolonged.

10. A computer-readable recording medium configured to store a program instruction to be applied to a method of generating a three-dimensional pattern to be formed at a template for use in a method of forming a pattern by filling a resist material in the three-dimensional pattern of the template,
the program instruction causing a computer to execute at least one of adjustment of a depth of the three-dimensional pattern, and division of the three-dimensional pattern, based on a relationship between a filling time of the resist material and a dimension or shape of the three-dimensional pattern.

11. The medium according to claim 10, wherein the depth of the three-dimensional pattern is adjusted such that a film thickness of a resist pattern formed by filling the resist material in the adjusted three-dimensional pattern of the template is not less than a desired thickness.

12. The medium according to claim 10, wherein the three-dimensional pattern is divided such that a film thickness of a resist pattern formed by filling the resist material in the divided three-dimensional pattern of the template is not less than a desired thickness.

13. The medium according to claim 10, wherein after the depth of the three-dimensional pattern to be formed at the template is adjusted, whether a film thickness of a resist pattern formed by filling the resist material in the three-dimensional pattern is not less than a desired thickness is determined, and the three-dimensional pattern is divided if the film thickness of the resist pattern is less than the desired thickness.

14. The medium according to claim 10, wherein at least one of the adjustment of the depth of the three-dimensional pattern and the division of the three-dimensional pattern is performed to satisfy a preset allowable resist material filling time.

15. A pattern formation method comprising:
bringing a template comprising a three-dimensional pattern generated by a method according to claim 1 into contact with a resist applied on a substrate;
filling the resist in the three-dimensional pattern; and
separating the template from the resist.
